(19) United States
(12) Patent Application Publication
(10) Pub. No.: US 2025/0026219 A1
(43) Pub. Date: Jan. 23, 2025

(54) GUN SEAT FOR CHARGING GUN AND CHARGING PILE

(71) Applicant: Autel Digital Power Co., Ltd., Shenzhen (CN)

(72) Inventor: Liang ZHANG, Shenzhen (CN)

(73) Assignee: Autel Digital Power Co., Ltd., Shenzhen, GD (CN)

(21) Appl. No.: 18/908,751

(22) Filed: Oct. 7, 2024

Related U.S. Application Data
(63) Continuation of application No. PCT/CN2023/081858, filed on Mar. 16, 2023.

(30) Foreign Application Priority Data
Apr. 7, 2022 (CN) 202220790300.4

(51) Int. Cl. B60L 53/31; B60L 53/16

(52) U.S. Cl. CPC B60L 53/31; B60L 53/16

(57) ABSTRACT

The present disclosure relates to the technical field of charging equipment, and provides a gun seat for a charging gun and a charging pile. The gun seat includes a front housing and a rear cover, the front housing is provided with a first opening through which a gun head of the charging gun enters and exits, the rear cover is fixedly connected to the front housing, the rear cover and the front housing are enclosed to form an accommodating chamber communicated with the first opening, and the accommodating chamber is configured to limit the gun head after the gun head enters the accommodating chamber from the first opening, so that after completing charging by using the charging pile, a user only needs to place the charging gun into the accommodating chamber from the first opening to complete resetting of the charging gun in the accommodating chamber.

### CROSS-REFERENCE TO RELATED APPLICATIONS

This application is a continuation application of International Patent Application No. PCT/CN2023/081858 filed on Mar. 16, 2023, which claims priority to Chinese Patent Application No. 202220790300.4, filed on Apr. 7, 2022, the entire disclosures of both of which are incorporated herein by reference for all purposes.

### TECHNICAL FIELD

The present disclosure relates to the technical field of charging piles, and more particularly, to a gun seat for a charging gun and a charging pile.

### BACKGROUND

With the continuous popularization of new energy vehicles adopting electric energy, such as battery electric vehicles (BEVs) and hybrid electric vehicles (HEVs), charging piles matching with the new energy vehicles also show explosive growth, so as to facilitate charging for the vehicles by users, and ensure the effective endurance of the vehicles. Specifically, when the vehicle needs to be charged, a charging gun on the charging pile is inserted into a charging port of the electric vehicle to achieve charging for the vehicle. After the charging for the vehicle is completed, the charging gun of the charging pile is plugged into a gun inserting seat of the charging pile.

At present, the gun inserting seat of the charging pile generally matches with a gun head of the charging gun in shape and is designed with a corresponding buckling device, and the locking of the gun inserting seat and the charging gun is achieved by the buckling device. However, for the gun inserting seat, in the process of achieving the locking of the charging gun and the gun inserting seat, the user needs to enable the gun head to exactly face the buckling device in the gun inserting seat, and ensure that the gun head is buckled with the buckling device in place, so as to ensure the locking of the charging gun in the gun inserting seat. In this process, the conditions that the charging gun is obliquely inserted and is unable to reset, the buckling is not in place, and the like, are likely to occur, so that the effective locking of the charging gun and the gun inserting seat may not be achieved, which causes the charging gun to fall off the gun inserting seat.

### SUMMARY

An aspect of the present disclosure aims at providing a gun seat for a charging gun and a charging pile, so as to solve at least the technical problem that it is difficult to buckle a gun inserting seat of the charging pile with the charging gun in the related art.

An aspect of the present disclosure solves the technical problem by adopting the following technical solutions: a gun seat for a charging gun is provided, including: a front housing provided with a first opening through which a gun head of the charging gun enters and exits, and a rear cover fixedly connected to the front housing, wherein the rear cover and the front housing are enclosed to form an accommodating chamber, the accommodating chamber is communicated with the first opening, and the accommodating chamber is configured to limit the gun head after the gun head enters the accommodating chamber from the first opening.

An aspect of the present disclosure solves the technical problem by adopting the following technical solutions: a charging pile is provided, and the charging pile includes the gun seat as described in the above technical solutions; and a charging gun; and a mounting panel, the gun seat being disposed on the mounting panel.

### BRIEF DESCRIPTION OF DRAWINGS

One or more embodiments are exemplarily illustrated with reference to drawings in the corresponding accompanying drawings. These exemplary illustrations do not constitute a limitation on the embodiments, elements having the same reference numerals in the accompanying drawings represent similar elements, and the drawings in the accompanying drawings do not constitute a limitation on scales, unless otherwise specified.

FIG. 1 is a schematic diagram showing a stereoscopic structure of a charging pile according to an embodiment of the present disclosure;

FIG. 2 is a schematic exploded diagram of a charging pile according to an embodiment of the present disclosure;

FIG. 3 is a schematic diagram showing a first structure of a charging gun according to an embodiment of the present disclosure;

FIG. 4 is a schematic diagram showing a second structure of a charging gun according to an embodiment of the present disclosure;

FIG. 5 is a schematic diagram showing a structure of a gun seat for a charging gun according to an embodiment of the present disclosure;

FIG. 6 is a schematic diagram showing a first structure of a front housing according to an embodiment of the present disclosure;

FIG. 7 is a schematic diagram showing a second structure of a front housing according to an embodiment of the present disclosure;

FIG. 8 is a schematic diagram showing a structure of a rear cover according to an embodiment of the present disclosure;

FIG. 9 is a schematic diagram showing a first assembly of a charging gun and a gun seat according to an embodiment of the present disclosure;

FIG. 10 is a schematic diagram showing a second assembly of a charging gun and a gun seat according to an embodiment of the present disclosure; and

FIG. 11 is a partial enlarged diagram of F in FIG. 5.

### DETAILED DESCRIPTION

In order to facilitate an understanding of the present disclosure, a more detailed description of the present disclosure is provided below in conjunction with the accompanying drawings and specific embodiments. It is to be noted that when an element is expressed as being “connected” to another element, the element may be directly on the other element, or one or more centered elements may be present between the two elements. As used herein, orientations or positional relationships indicated by the terms “upper,” “lower,” “left,” “right,” “upper end,” “lower end,” “top,” “bottom,” and the like are orientations or positional relationships as shown in the accompanying drawings, which are merely to facilitate the description of the present disclosure and to simplify the description, and do not indicate or imply that the referenced devices or elements must have a particular orientation and be constructed and operated in a particular orientation, and thus should not be construed as limiting the present disclosure. Furthermore, the terms “first,” “second,” and the like are used for descriptive purposes only and are not to be construed as indicating or implying relative importance.

Unless otherwise defined, all technical and scientific terms used herein have the same meaning as commonly understood by those skilled in the art to which the present disclosure belongs. The terms used in the description of the present disclosure are for the purpose of describing particular embodiments only and are not intended to limit the present disclosure.

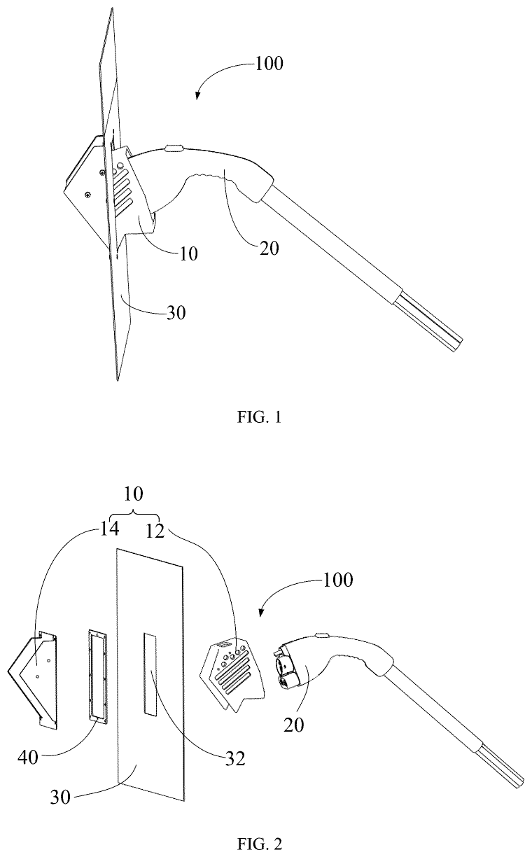

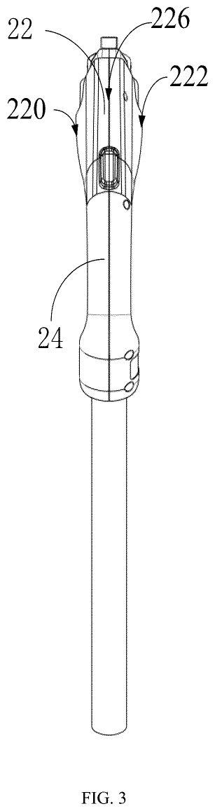

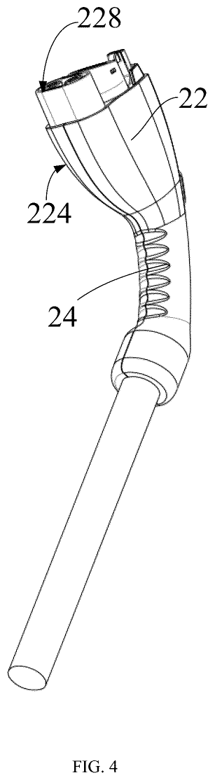

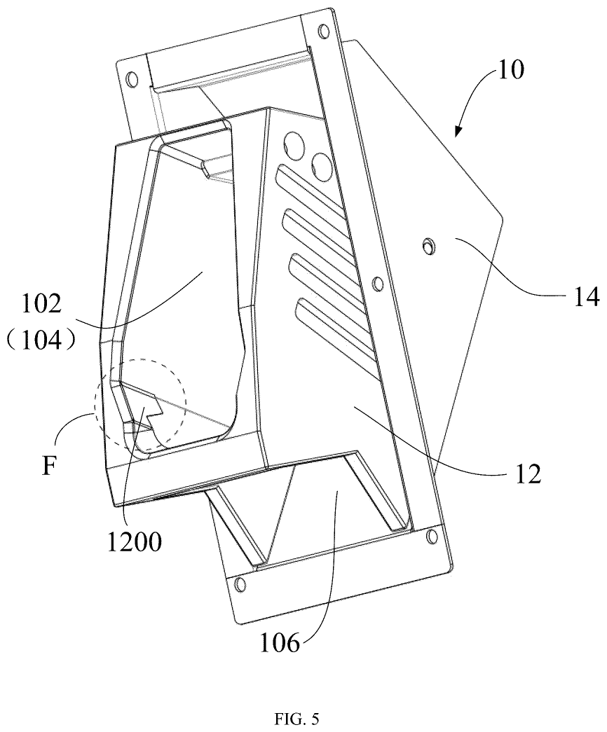

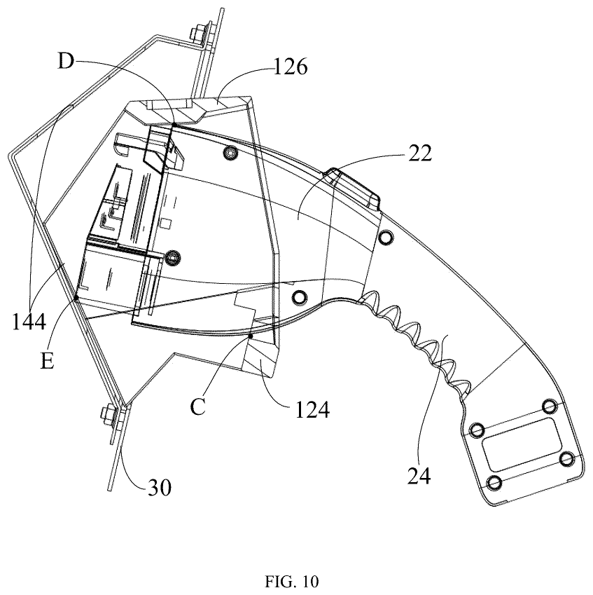

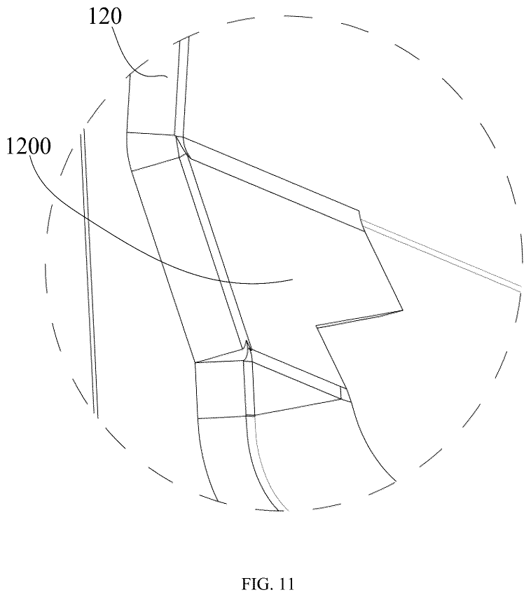

A gun seat for a charging gun and a charging pile provided in embodiments of the present disclosure will be described in detail below with reference to FIG. 1 to FIG. 11.

Reference numerals: 100. charging pile; 10. gun seat; 102. accommodating chamber; 104. first opening; 106. second opening; 12. front housing; 120. first side plate; 1200. first abutting portion; 122. second side plate; 1220. second abutting portion; 124. supporting plate; 1240. third abutting portion; 126. top plate; 1260. fourth abutting portion; 1262. abutting surface; 1264. first guide surface; 1266. second guide surface; 14. rear cover; 140. third side plate; 142. fourth side plate; 144. inner embedded plate; 1440. fifth abutting portion; 20. charging gun; 22. gun head; 220. first side of gun head; 222. second side of gun head; 224. bottom of gun head; 226. top of gun head; 228. end of gun head; 24. handle; 30. mounting panel; 32. through hole; 40. gasket; A. first stress contact point; B. second stress contact point; C. third stress contact point; D. fourth stress contact point; and E. fifth stress contact point.

Referring to FIG. 1 to FIG. 4, the charging pile 100 provided in the embodiment of the present disclosure includes a gun seat 10, a charging gun 20 and a mounting panel 30, where the gun seat 10 is fixedly mounted on the mounting panel 30, and the charging gun 20 may be placed in the gun seat 10. In some examples, a charging gun may be referred to as a charging connector, a charging plug, a charging handle, a charging coupler, etc.

The charging gun 20 includes a gun head 22 and a handle 24, where the gun head 22 is connected at a tail end of the handle 24, the gun head 22 is placed in the gun seat 10, the handle 24 is disposed outside the gun seat 10, a surface of the gun head 22 may present a regular or irregular shape, the gun head 22 includes a top 226 of gun head, a bottom 224 of gun head, a first side 220 of gun head and a second side 222 of gun head, a surface of the top 226 of gun head, a surface of the bottom 224 of gun head, a surface of the first side 220 of gun head and a surface of the second side 222 of gun head are enclosed together to form the surface of the gun head 22, a plug connector is further disposed at an end 228 of gun head, and the plug connector may be plugged with a charging port in an electric vehicle.

When a user needs to use the charging pile 100 for charging, the user lifts the handle 24 to take out the gun head 22 from the gun seat 10, so that the gun head 22 is inserted into the charging port in the electric vehicle to charge the electric vehicle, and after charging is completed, the gun head 22 is placed into the gun seat 10 to achieve resetting of the charging gun 20.

Referring to FIG. 5, in some embodiments, the gun seat 10 includes: a front housing 12 and a rear cover 14, where the front housing 12 is fixedly connected to the rear cover 14 to be fixed on the mounting panel 30 together, the front housing 12 and the rear cover 14 are enclosed to form an accommodating chamber 102, the front housing 12 is provided with a first opening 104, the first opening 104 is communicated with the accommodating chamber 102, and the gun head 22 may enter and exit through the first opening 104. The user may place the gun head 22 into the accommodating chamber 102 through the first opening 104, and then, under the action of own gravity of the charging gun 20, the surface of the gun head 22 may contact an inner surface of the accommodating chamber 102, a plurality of stress contact points may be generated, and the limiting for the gun head 22 is achieved by the plurality of stress contact points, so that the gun head 22 is limited in the accommodating chamber 102 and is not easy to pull out.

In this embodiment, the front housing 12 and the rear cover 14 are respectively disposed on two sides of the mounting panel 30, namely, the mounting panel 30 is disposed between the front housing 12 and the rear cover 14, the mounting panel 30 is provided with a through hole 32, and the through hole is used for communicating an inner chamber of the front housing 12 with an inner chamber of the rear cover 14 to form the accommodating chamber 102.

In some embodiments, the rear cover 14 is assembled and connected to the mounting panel 30 by a screw, and a gasket 40 may be disposed between the rear cover 14 and the mounting panel 30 to increase the assembling firmness of the of the rear cover 14 and the mounting panel 30.

In some embodiments, the gasket 40 is a silicone rubber gasket, as the silicone rubber gasket has a good waterproof property, after the rear cover 14, the mounting panel 30 and the silicone rubber gasket are assembled, the silicone rubber gasket is tightly fitted with the rear cover 14 and the mounting panel 30 to prevent damage to the charging pile 100 caused by penetration of accumulated water in the accommodating chamber 102 into the interior of the charging pile 100 through a gap between the rear cover 14 and the mounting panel 30. In addition, the silicone rubber gasket may also improve the anti-slip performance between the rear cover 14 and the mounting panel 30, thereby further improving the assembling stability.

In some embodiments, a second opening 106 is further formed between the front housing 12 and the rear cover 14, the second opening 106 is communicated with the accommodating chamber 102, and the second opening 106 is used for discharging the accumulated water in the accommodating chamber 102.

In some embodiments, a direction of the second opening 106 is vertically downward, so that the accumulated water in the accommodating chamber 102 is quickly discharged.

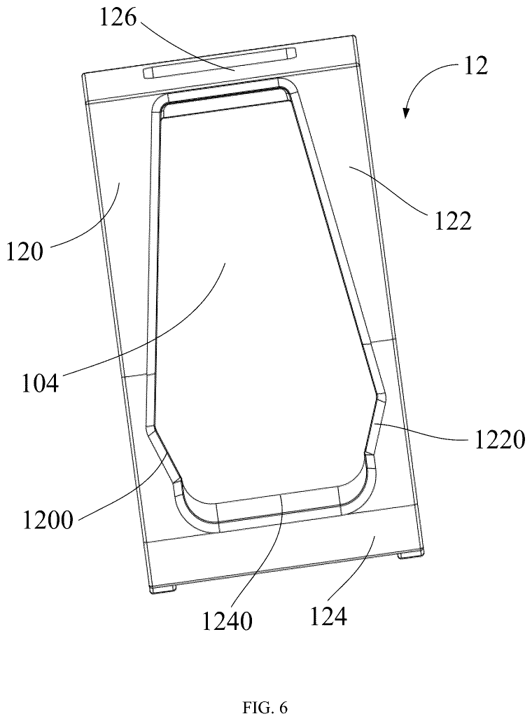

Referring to FIG. 6 to FIG. 8, in some embodiments, the front housing 12 is disposed on an outer side of the mounting panel 30 and includes a first side plate 120, a second side plate 122, a supporting plate 124 and a top plate 126. The rear cover 14 is disposed on an inner side of the mounting panel 30 and fixedly mounted on the mounting panel 30.

The rear cover 14 includes an inner embedded plate 144, a third side plate 140 and a fourth side plate 142, where the third side plate 140 and the fourth side plate 142 are respectively disposed on two sides of the inner embedded plate 144, the inner embedded plate 144, the third side plate 140 and the fourth side plate 142 are enclosed to form an accommodating space, the first side plate 120 and the second side plate 122 are disposed in the accommodating space, the first side plate 120 is fixedly connected to the third side plate 140, and the second side plate 122 is fixedly connected to the fourth side plate 142, so as to achieve the assembly among the rear cover 14, the front housing 12 and the mounting panel 30. After the rear cover 14 and the front housing 12 are mounted to the mounting panel 30, the accommodating chamber 102 is formed by the first side plate 120, the second side plate 122, the supporting plate 124, the top plate 126 and the inner embedded plate 144, at most five stress contact points may be formed by the first side plate 120, the second side plate 122, the supporting plate 124, the top plate 126 and the inner embedded plate 144 with the gun head 22 in the accommodating chamber 102 to limit the gun head 22 in the accommodating chamber 102.

The first side plate 120 and the second side plate 122 are disposed opposite to each other, the first side plate 120 and the second side plate 122 are disposed in the inner chamber of the rear cover 14 and fixedly connected to the rear cover 14, the supporting plate 124 and the top plate 126 are both disposed between the first side plate 120 and the second side plate 122, the supporting plate 124 is disposed close to one side of the first opening 104 and disposed on one side of the bottoms of the first side plate 120 and the second side plate 122, two ends of the supporting plate 124 are respectively connected to the first side plate 120 and the second side plate 122, the top plate 126 is disposed on one side of the tops of the first side plate 120 and the second side plate 122, and two ends of the top plate 126 are respectively connected to the first side plate 120 and the second side plate 122.

After the user places the gun head 22 into the accommodating chamber 102 through the first opening 104, the gun head 22 is positioned between the first side plate 120 and the second side plate 122, and the first side plate 120 and the second side plate 122 are respectively disposed on a first side 220 of gun head and a second side 222 of gun head to limit the movement of the gun head 22 in a horizontal direction together. Meanwhile, the gun head 22 is disposed between the supporting plate 124 and the top plate 126, the supporting plate 124 is disposed at the bottom 224 of gun head, the top plate 126 is disposed at the top 226 of gun head, and the supporting plate 124 and the top 226 limit the movement of the gun head in a vertical direction together, so that the gun head 22 is reliably limited in the accommodating chamber 102 under the action of mutual matching of the first side plate 120, the second side plate 122, the supporting plate 124 and the top plate 126.

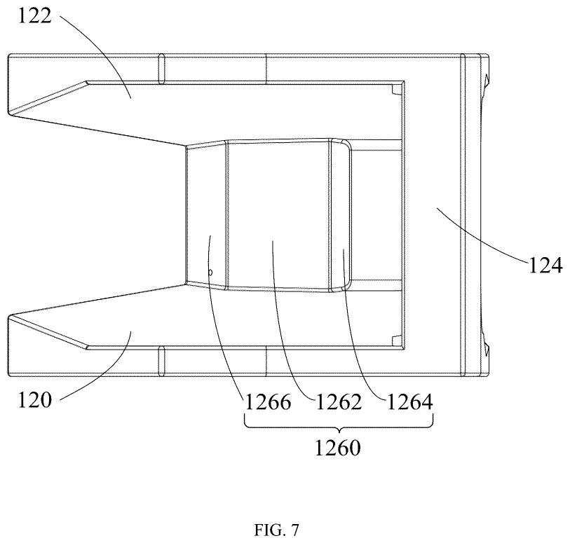

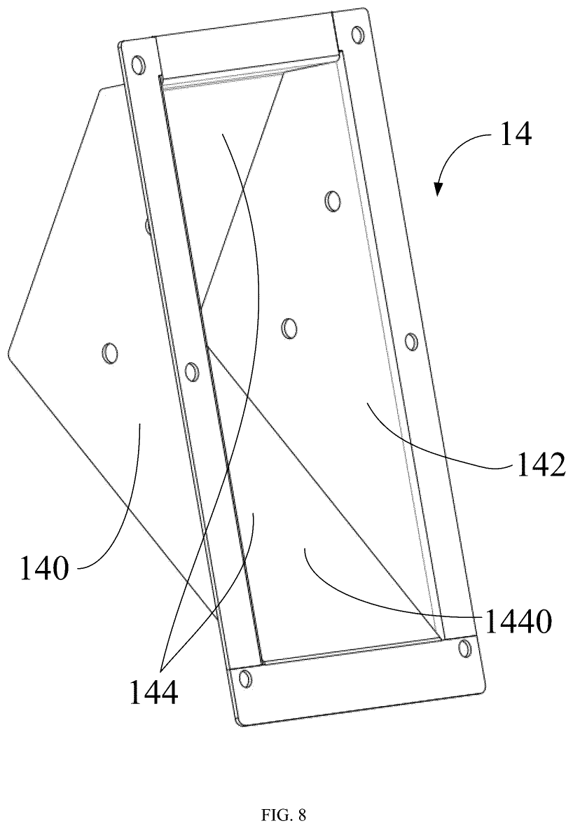

Referring to FIG. 9 to FIG. 11, and referring again to FIG. 6 and FIG. 7, in some embodiments, a first abutting portion 1200 is disposed on an inner surface of the first side plate 120, a second abutting portion 1220 is disposed on an inner surface of the second side plate 122, the first abutting portion 1200 and the second abutting portion 1220 are disposed opposite to each other, under the action of own gravity of the gun head 22 disposed in the accommodating chamber 102, the first abutting portion 1200 may abut a surface of a first side 220 of gun head, so that a first stress contact point A is generated by the first abutting portion 1200 and the surface of the first side 220 of gun head, the second abutting portion 1220 may abut a surface of a second side 222 of gun head, so that a second stress contact point B is generated by the second abutting portion 1220 and the surface of the second side 222 of gun head, the first stress contact point A and the second stress contact point B act on the surfaces of the two sides of the gun head 22 simultaneously and match with each other to achieve the limiting for the surfaces of the two sides of the gun head 22, and prevent the gun head 22 from shaking in the left-right direction.

In some embodiments, a third abutting portion 1240 is disposed on an inner surface of the supporting plate 124, a fourth abutting portion 1260 is disposed on an inner surface of the top plate 126, the fourth abutting portion 1260 and the third abutting portion 1240 may match with each other, under the action of own gravity of the gun head 22 disposed in the accommodating chamber 102, the surface of the bottom 224 of gun head firstly abuts the third abutting portion 1240 to generate a third stress contact point C, and then the gun head 22 takes the third stress contact point C as a fulcrum and continues to rotate under the action of its own gravity, so that one side of the handle 24 of the charging gun rotates downwards under the action of its own gravity, one side of the end 228 of gun head rotates upwards, the surface of the top 226 of gun head abuts the fourth abutting portion 1260 to generate a fourth stress contact point D, and the third stress contact point C and the fourth stress contact point D match with each other to achieve the limiting for the surface of the bottom 224 of gun head and the surface of the top 226 of gun head, so as to prevent the gun head 22 from shaking in the vertical direction.

In this embodiment, after completing the charging by using the charging pile 100, the user only needs to place the gun head 22 into the accommodating chamber 102, and then the first stress contact point A, the second stress contact point B, the third stress contact point C and the fourth stress contact point D are respectively generated by the first side plate 120, the second side plate 122, the supporting plate 124 and the top plate 126 with the gun head 22, so that the displacement of the gun head 22 in the accommodating chamber 102 may be automatically limited by matching the four stress contact points together, and self-resetting of the gun head 22 in the accommodating chamber 102 is achieved, while when the user needs to pull the gun head 22 out of the accommodating chamber 102, the gun head 22 may be pulled out of the accommodating chamber 102 by slightly lifting the handle 24 of the charging gun to release the stress contact between the first abutting portion 1200, the second abutting portion 1220, the third abutting portion 1240 and the fourth abutting portion 1260 and the gun head 22.

In some embodiments, the first abutting portion 1200 is a first limiting plate, the first limiting plate is close to one side of the first opening 104, and a surface of the first limiting plate may abut against a surface of a first side 220 of gun head; and the second abutting portion 1220 is a second limiting plate, the second limiting plate is close to one side of the first opening 104, and a surface of the second limiting plate may abut against a surface of a second side 222 of gun head.

In this embodiment, the first limiting plate is disposed on an inner surface of the first side plate 120, the first limiting plate may be integrally molded with the first side plate 120, the second limiting plate is disposed on an inner surface of the second side plate 122, the second limiting plate may be integrally molded with the second side plate 122, the first limiting plate and the second limiting plate are disposed opposite to each other and both disposed near the first opening 104, and the first limiting plate and the second limiting plate may be used for limiting the movement of the gun head 22 towards a direction of the first opening 104 (a pull-out direction of the gun head 22) in addition to limiting the surfaces of the two sides of the gun head 22, thereby preventing the gun head 22 from being pulled out due to unintended touch of the gun head 22.

In some embodiments, a horizontal distance between the first limiting plate and the second limiting plate gradually decreases in a direction of gravity of the charging gun 20, namely, in a vertically downward direction, the horizontal distance between the first limiting plate and the second limiting plate gradually decreases. During a movement process of the gun head 22 in the accommodating chamber 102 in the vertically downward direction under the action of its own gravity, the surfaces of the two sides of the gun head 22 respectively abut the first limiting plate and the second limiting plate to stop the movement, thereby achieving the limiting for the gun head 22 in the left-right direction by the first limiting plate and the second limiting plate.

In some embodiments, the horizontal distance between the first limiting plate and the second limiting plate gradually increases in a horizontal entry direction of the gun head 22 from the first opening 104, namely, in the pull-out direction of the gun head 22, the horizontal distance between the first limiting plate and the second limiting plate gradually decreases, thereby limiting the movement of the gun head 22 towards the pull-out direction of the gun head 22, so that the gun head 22 is more reliably fixed in the accommodating chamber 102.

In some embodiments, the fourth abutting portion 1260 is a limiting block, the limiting block may be integrally molded with the top plate 126, and the limiting block is disposed on an inner surface of the top plate 126 and may abut a surface of the top 226 of gun head.

In some embodiments, the limiting block includes an abutting surface 1262, a first guide surface 1264 and a second guide surface 1266, where the abutting surface 1262 is parallel to an inner surface of the top plate 126, the abutting surface 1262 may abut against the surface of the top 226 of gun head 22 to generate the fourth stress contact point D, the first guide surface 1264 and the second guide surface 1266 are both slopes and are disposed on two sides of the abutting surface 1262, the first guide surface 1264 is disposed on one side close to the first opening 104, and the inner surface of the top plate 126 is connected to the abutting surface 1262 by the first guide surface 1264. When the gun head 22 enters the accommodating chamber 102 from the first opening 104, the gun head 22 may be guided to enter the accommodating chamber 102 more conveniently and quickly under the guidance of the first guide surface 1264. The second guide surface 1266 is disposed on one side away from the first opening 104, and after the gun head 22 enters the accommodating chamber 102, one side of the handle 24 of the charging gun rotates downwards under the action of its own gravity, so that one side of the end 228 of gun head rotates upwards, the surface of the top 226 of gun head firstly abuts against the second guide surface 1266, and then as the gun head 22 continues to rotate, the second guide surface 1266 guides the surface of the top 226 of gun head to finally abut against the abutting surface 1262 of the limiting block to generate the fourth stress contact point D.

It is to be noted that in other embodiments, the fourth stress contact point D may also be a point where the second guide surface 1266 contacts with the surface of the top 226 of gun head.

As the first stress contact point A, the second stress contact point B, the third stress contact point C and the fourth stress contact point D are all stress points generated when the front housing 12 contacts with the gun head, in order to avoid scratching or wearing the gun head when the front housing 12 contacts with the gun head 22, in some embodiments, a flexible material, such as plastic, is selected to make the front housing 12, so that the front housing 12 flexibly contacts with the gun head 22, so as to avoid scratching or wearing when the gun head 22 contacts with the inner chamber of the front housing 12.

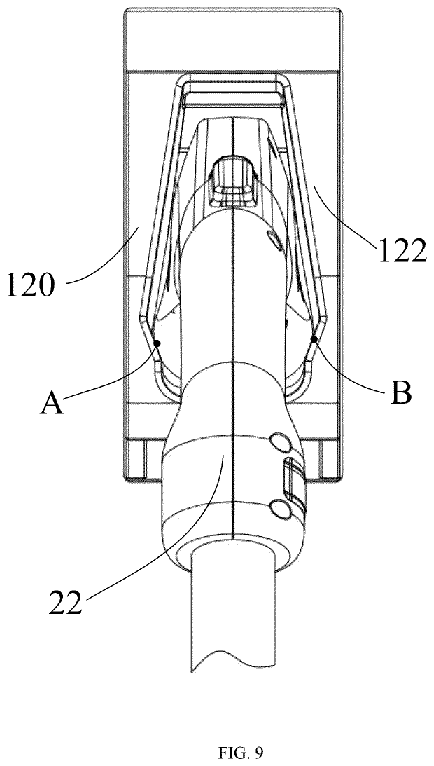

Referring again to FIG. 8, in some embodiments, the inner embedded plate 144 is further provided with a fifth abutting portion 1440, and the fifth abutting portion 1440 may abut against an end 228 of gun head to limit the end 228 of gun head.

In this embodiment, the fifth abutting portion 1440 is a plane which is disposed on an inner surface of the inner embedded plate 144, under the action of own gravity of the gun head 22 disposed in the accommodating chamber 102, the surface of the bottom 224 of gun head firstly abuts the third abutting portion 1240 to generate the third stress contact point C, and then the gun head 22 rotates with the third stress contact point C as a fulcrum, so that the end 228 of gun head abuts the inner surface of the inner embedded plate 144 to generate the fifth stress contact point E, and the fifth stress contact point E further limits the gun head 22 in the accommodating chamber 102, so as to limit the movement of the gun head 22 towards the entry direction of the gun head, and enable the gun head 22 to be more reliably fixed in the accommodating chamber 102.

In some embodiments, the inner embedded plate 144 is a V-shaped plate, and the V-shaped plate not only may achieve the abutting between the end 228 of gun head and an inner surface of the V-shaped plate, but also may guide accumulated water inside the accommodating chamber 102 to flow out of the second opening 106 by the V-shaped plate.

In some embodiments, the front housing includes: a first side plate and a second side plate which are fixedly connected to the rear cover, the first side plate and the second side plate being respectively configured for limiting two sides of the gun head; a supporting plate disposed on one side of the first opening, two ends of the supporting plate being respectively connected to the first side plate and the second side plate, and the supporting plate being configured for limiting a bottom of the gun head; and a top plate, two ends of the top plate being respectively connected to the first side plate and the second side plate, and the top plate being configured for limiting a top of the gun head.

In some embodiments, a first abutting portion is disposed on an inner surface of the first side plate, and the first abutting portion is configured to abut a surface of a first side of the gun head; and a second abutting portion is disposed on an inner surface of the second side plate, the second abutting portion is configured to abut a surface of a second side of the gun head, and the first abutting portion and the second abutting portion are disposed opposite to each other and match with each other to limit two side surfaces of the gun head.

In some embodiments, the first abutting portion is a first limiting plate, the first limiting plate is close to one side of the first opening, and a surface of the first limiting plate is configured to abut against a side surface of the gun head; and the second abutting portion is a second limiting plate, the second limiting plate is close to one side of the first opening, and a surface of the second limiting plate is configured to abut against the other side surface of the gun head.

In some embodiments, a horizontal distance between the first limiting plate and the second limiting plate gradually decreases in a direction of gravity of the charging gun; and/or the horizontal distance between the first limiting plate and the second limiting plate gradually increases in a horizontal entry direction of the gun head from the first opening.

In some embodiments, a third abutting portion is disposed on an inner surface of the supporting plate, a fourth abutting portion is disposed on an inner surface of the top plate, and the third abutting portion and the fourth abutting portion match with each other and are configured to respectively abut against a top surface of the gun head and a bottom surface of the gun head to limit the gun head.

In some embodiments, the fourth abutting portion is a limiting block, and the limiting block includes: an abutting surface capable of abutting against the top surface of the gun head; and a first guide surface and a second guide surface respectively disposed on two sides of the abutting surface, the first guide surface facing one side of the first opening for guiding the gun head to enter the accommodating chamber from the first opening, and the second guide surface being disposed on one side away from the first opening for guiding the top surface of the gun head to abut against the abutting surface.

In some embodiments, the rear cover includes: an inner embedded plate provided with a fifth abutting portion, the fifth abutting portion being capable of abutting against an end of the gun head to limit the end of the gun head; and a third side plate and a fourth side plate respectively disposed on two sides of the inner embedded plate, the third side plate being disposed on an outer side of the first side plate and fixedly connected to the first side plate, and the fourth side plate being disposed on an outer side of the second side plate and fixedly connected to the second side plate.

In some embodiments, a second opening is further formed between the front housing and the rear cover, the second opening is communicated with the accommodating chamber, and the second opening is configured for discharging accumulated water in the accommodating chamber.

Compared with the related art, in the gun seat for the charging gun and the charging pile provided in the embodiments of the present disclosure, the gun seat includes the front housing and the rear cover, where the front housing is provided with the first opening through which the gun head enters and exits, the rear cover is fixedly connected to the front housing, the rear cover and the front housing are enclosed to form the accommodating chamber, the accommodating chamber is communicated with the first opening, and after a user places the gun head into the accommodating chamber from the first opening, the accommodating chamber may limit the gun head to fix the gun head in the accommodating chamber.

Finally, it should be noted that the above embodiments are merely illustrative of the technical solutions of the present disclosure, rather than limiting the technical solutions; under the idea of the present disclosure, the technical features in the above embodiments or different embodiments may also be combined, the steps may be implemented in any order, and there are many other changes of different aspects of the present disclosure as described above, which are not provided in the details for the sake of brevity; although the present disclosure has been described in detail with reference to the foregoing embodiments, those ordinarily skilled in the art will understand that the technical solutions disclosed in the various embodiments described above may still be modified, or some of the technical features thereof may be substituted with equivalents; however, these modifications or substitutions do not make the essence of the corresponding technical solutions depart from the scopes of the technical solutions in the various embodiments of the present disclosure.

The foregoing is only the specific embodiment of the present disclosure, but the scope of protection of the present disclosure is not limited to this, those skilled in the art may easily think of changes or substitutions within the technical scope disclosed by the present disclosure, and these changes or substitutions shall be covered by the scope of protection of the present disclosure. Therefore, the scope of protection of the present disclosure shall be subject to the scope of protection of the claims.

What is claimed is:

1. A gun seat for a charging gun, comprising:
a front housing provided with a first opening through which a gun head of the charging gun enters and exits, and
a rear cover fixedly connected to the front housing, wherein the rear cover and the front housing are enclosed to form an accommodating chamber, the accommodating chamber is communicated with the first opening, and the accommodating chamber is configured to limit the gun head after the gun head enters the accommodating chamber from the first opening.

2. The gun seat according to claim 1, wherein the front housing comprises:
a first side plate and a second side plate which are fixedly connected to the rear cover, the first side plate and the second side plate being respectively configured for limiting two sides of the gun head;
a supporting plate disposed on one side of the first opening, two ends of the supporting plate being respectively connected to the first side plate and the second side plate, and the supporting plate being configured for limiting a bottom of the gun head; and
a top plate, two ends of the top plate being respectively connected to the first side plate and the second side plate, and the top plate being configured for limiting a top of the gun head.

3. The gun seat according to claim 2, wherein
a first abutting portion is disposed on an inner surface of the first side plate, and the first abutting portion is configured to abut a surface of a first side of the gun head; and
a second abutting portion is disposed on an inner surface of the second side plate, the second abutting portion is configured to abut a surface of a second side of the gun head, and the first abutting portion and the second abutting portion are disposed opposite to each other and match with each other to limit two side surfaces of the gun head.

4. The gun seat according to claim 3, wherein
the first abutting portion is a first limiting plate, the first limiting plate is close to one side of the first opening, and a surface of the first limiting plate is configured to abut against a side surface of the gun head; and
the second abutting portion is a second limiting plate, the second limiting plate is close to the one side of the first opening, and a surface of the second limiting plate is configured to abut against the other side surface of the gun head.

5. The gun seat according to claim 4, wherein
a horizontal distance between the first limiting plate and the second limiting plate gradually decreases in a direction of gravity of the charging gun;
and/or
the horizontal distance between the first limiting plate and the second limiting plate gradually increases in a horizontal entry direction of the gun head from the first opening.

6. The gun seat according to claim 2, wherein
a third abutting portion is disposed on an inner surface of the supporting plate, a fourth abutting portion is disposed on an inner surface of the top plate, and the third abutting portion and the fourth abutting portion match with each other and are configured to respectively abut against a top surface of the gun head and a bottom surface of the gun head to limit the gun head.

7. The gun seat according to claim 6, wherein the fourth abutting portion is a limiting block, and the limiting block comprises:
an abutting surface configured to abut against the top surface of the gun head; and
a first guide surface and a second guide surface respectively disposed on two sides of the abutting surface, the first guide surface facing one side of the first opening for guiding the gun head to enter the accommodating chamber from the first opening, and the second guide surface being disposed on one side away from the first opening for guiding the top surface of the gun head to abut against the abutting surface.

8. The gun seat according to claim 2, wherein the rear cover comprises:
an inner embedded plate provided with a fifth abutting portion, the fifth abutting portion being configured to abut against an end of the gun head to limit the end of the gun head; and
a third side plate and a fourth side plate respectively disposed on two sides of the inner embedded plate, the third side plate being disposed on an outer side of the first side plate and fixedly connected to the first side plate, and the fourth side plate being disposed on an outer side of the second side plate and fixedly connected to the second side plate.

9. The gun seat according to claim 1, wherein a second opening is further formed between the front housing and the rear cover, the second opening is communicated with the accommodating chamber, and the second opening is configured for discharging accumulated water in the accommodating chamber.

10. A charging pile, comprising:
a gun seat;
a charging gun; and
a mounting panel, the gun seat being disposed on the mounting panel,
wherein the gun seat comprises:
a front housing provided with a first opening through which a gun head of the charging gun enters and exits, and
a rear cover fixedly connected to the front housing, wherein the rear cover and the front housing are enclosed to form an accommodating chamber, the accommodating chamber is communicated with the first opening, and the accommodating chamber is configured to limit the gun head after the gun head enters the accommodating chamber from the first opening.

11. The gun seat according to claim 2, wherein a second opening is further formed between the front housing and the rear cover, the second opening is communicated with the accommodating chamber, and the second opening is configured for discharging accumulated water in the accommodating chamber.

12. The gun seat according to claim 3, wherein a second opening is further formed between the front housing and the rear cover, the second opening is communicated with the accommodating chamber, and the second opening is configured for discharging accumulated water in the accommodating chamber.

13. The gun seat according to claim 4, wherein a second opening is further formed between the front housing and the rear cover, the second opening is communicated with the accommodating chamber, and the second opening is configured for discharging accumulated water in the accommodating chamber.

14. The gun seat according to claim 5, wherein a second opening is further formed between the front housing and the rear cover, the second opening is communicated with the accommodating chamber, and the second opening is configured for discharging accumulated water in the accommodating chamber.

15. The gun seat according to claim 6, wherein a second opening is further formed between the front housing and the rear cover, the second opening is communicated with the accommodating chamber, and the second opening is configured for discharging accumulated water in the accommodating chamber.

16. The gun seat according to claim 7, wherein a second opening is further formed between the front housing and the rear cover, the second opening is communicated with the accommodating chamber, and the second opening is configured for discharging accumulated water in the accommodating chamber.

17. The gun seat according to claim 8, wherein a second opening is further formed between the front housing and the rear cover, the second opening is communicated with the accommodating chamber, and the second opening is configured for discharging accumulated water in the accommodating chamber.

18. The charging pile according to claim 10, wherein the front housing comprises:
a first side plate and a second side plate which are fixedly connected to the rear cover, the first side plate and the second side plate being respectively configured for limiting two sides of the gun head;
a supporting plate disposed on one side of the first opening, two ends of the supporting plate being respectively connected to the first side plate and the second side plate, and the supporting plate being configured for limiting a bottom of the gun head; and
a top plate, two ends of the top plate being respectively connected to the first side plate and the second side plate, and the top plate being configured for limiting a top of the gun head.

19. The charging pile according to claim 18, wherein
a first abutting portion is disposed on an inner surface of the first side plate, and the first abutting portion is configured to abut a surface of a first side of the gun head; and
a second abutting portion is disposed on an inner surface of the second side plate, the second abutting portion is configured to abut a surface of a second side of the gun head, and the first abutting portion and the second abutting portion are disposed opposite to each other and match with each other to limit two side surfaces of the gun head.

20. The charging pile according to claim 19, wherein
the first abutting portion is a first limiting plate, the first limiting plate is close to one side of the first opening, and a surface of the first limiting plate is configured to abut against a side surface of the gun head; and
the second abutting portion is a second limiting plate, the second limiting plate is close to the one side of the first opening, and a surface of the second limiting plate is configured to abut against the other side surface of the gun head.
